(19) United States
(12) Patent Application Publication
(10) Pub. No.: US 2026/0164097 A1
(43) Pub. Date: Jun. 11, 2026

(54) METHOD, APPARATUS, DEVICE AND STORAGE MEDIUM FOR GENERATING A VIDEO

(71) Applicant: Beijing Zitiao Network Technology Co., Ltd., Beijing (CN)

(72) Inventors: Yongming ZHU, Beijing (CN); Zhengkun RONG, Beijing (CN); Tianshu HU, Beijing (CN); Longhao ZHANG, Beijing (CN); Zhipeng GE, Beijing (CN); Shuang LIANG, Beijing (CN)

(21) Appl. No.: 19/411,009

(22) Filed: Dec. 5, 2025

(30) Foreign Application Priority Data
Dec. 5, 2024 (CN) 202411784420.3

(51) Int. Cl. H04N 21/81; G06T 5/70; G06T 7/246; G06V 40/16

(52) U.S. Cl. CPC H04N 21/816; G06T 5/70; G06T 7/246; G06V 40/168; G06T 2207/20182; G06T 2207/30201

(57) ABSTRACT

The embodiments of the disclosure provide a method, an apparatus, a device, a storage medium and a program product for generating a video. The method includes: obtaining a reference image and a conversational speech, the reference image comprising a target object, and the conversational speech comprising a target speech corresponding to the target object and an interactive speech for interacting with the target object; generating, based on the reference image, reference motion feature information and reference visual feature information corresponding to a face of the target object; extracting interactive motion feature information of the conversational speech; determining, based on at least the interactive motion feature information, a motion feature information sequence corresponding to the conversational speech; and generating a target video based on the reference motion feature information, the reference visual feature information, and the motion feature information sequence.

### CROSS-REFERENCE

The present application claims priority to Chinese Patent Application No. 202411784420.3, filed on Dec. 5, 2024 and entitled “METHOD, APPARATUS, DEVICE AND STORAGE MEDIUM FOR GENERATING A VIDEO”, the disclosures of which are incorporated herein by reference in its entirety.

### FIELD

The example embodiments of the present disclosure generally relate to the field of computer technologies, and in particular, to a method, an apparatus, a device, and computer-readable storage medium for generating a video.

### BACKGROUND

In recent years, in order to construct conversational agents, researchers have paid sufficient attention to audio-driven face generation. However, most research focuses only on one-sided communication, such as speaking or listening, ignoring the duality in human-to-human interaction. Speaker face generation technology aims to synthesize the face animation of the speaker from the reference image of the speaker and the driving audio. Although the related work can produce vivid videos with accurate lip synchronization, they only emphasize the role of the speaker, and ignore the feedback of the listener. The listener face generation technology aims to react to the behavior of a speaker. However, the related work limits the audience's response to non-verbal facial actions, which is quite different from real-life interactive scenarios. How to improve the interactivity in face generation has always been a concern.

### SUMMARY

In a first aspect of the present disclosure, a method for generating a video is provided. The method comprises: obtaining a reference image and a conversational speech, the reference image comprising a target object, and the conversational speech comprising a target speech corresponding to the target object and an interactive speech for interacting with the target object; generating, based on the reference image, reference motion feature information and reference visual feature information corresponding to a face of the target object; extracting interactive motion feature information of the conversational speech; determining, based on at least the interactive motion feature information, a motion feature information sequence corresponding to the conversational speech; and generating a target video based on the reference motion feature information, the reference visual feature information, and the motion feature information sequence.

In a second aspect of the present disclosure, an apparatus for generating a video is provided. The apparatus comprises: an input obtaining module configured to obtain a reference image and a conversational speech, the reference image comprising a target object, and the conversational speech comprising a target speech corresponding to the target object and an interactive speech for interacting with the target object; a feature information generating module configured to generate, based on the reference image, reference motion feature information and reference visual feature information corresponding to a face of the target object; an interactive motion feature information extracting module configured to extract interactive motion feature information of the conversational speech; a motion feature information sequence determining module configured to determine, based on at least the interactive motion feature information, a motion feature information sequence corresponding to the conversational speech; and a target video generating module configured to generate a target video based on the reference motion feature information, the reference visual feature information, and the motion feature information sequence.

In a third aspect of the present disclosure, an electronic device is provided. The electronic device includes at least one processor; and at least one memory coupled to the at least one processor and storing instructions for execution by the at least one processor. The instructions, when executed by the at least one processor, cause the electronic device to perform the method of the first aspect.

In a fourth aspect of the present disclosure, a computer-readable storage medium is provided. The computer-readable storage medium has stored thereon a computer program that, when executed by a processor, implements the method of the first aspect.

In a fifth aspect of the present disclosure, a computer program product is provided. The computer program product comprises a computer program that, when executed by a processor, implements the method of the first aspect.

It should be understood that the content described in this section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure can be implemented;

FIG. 2 illustrates an inference process of a video generation model according to some embodiments of the present disclosure;

FIG. 3 is a schematic architectural diagram of a motion extraction model according to some embodiments of the present disclosure;

FIG. 4 illustrates a schematic diagram of extracting style feature information according to some embodiments of the present disclosure;

FIG. 5 shows a flowchart of a method for generating a video according to some embodiments of the present disclosure;

FIG. 6 illustrates an example structural block diagram of an apparatus for generating a video according to some embodiments of the present disclosure; and

FIG. 7 illustrates a block diagram of an electronic device in which one or more embodiments of the present disclosure may be implemented.

### DETAILED DESCRIPTION

The embodiments of the present disclosure will be described in more detail with reference to the accompanying drawings. Although some embodiments of the present disclosure have been illustrated in the drawings, it should be understood that the present disclosure can be implemented in various manners, and thus should not be construed to be limited to embodiments disclosed herein. On the contrary, those embodiments are provided for the thorough and complete understanding of the present disclosure. It should be understood that the drawings and embodiments of the present disclosure are only used for illustration, rather than limiting the protection scope of the present disclosure.

In the description of embodiments of the present disclosure, the terms “comprise” and its variants used herein are to be read as open terms that mean “include, but is not limited to.” The term “based on” is to be read as “based at least in part on.” The term “one embodiment” or “the embodiment” is to be read as “at least one embodiment.” The term “some embodiments” is to be read as “at least some embodiments.” Other definitions, explicit and implicit, might be included below.

It may be understood that the data involved in the technical solution (including but not limited to the data itself, the obtaining or use of the data) should follow the requirements of the corresponding laws and regulations and related regulations.

It will be appreciated that before using the technical solution disclosed in each embodiment of the present disclosure, users should be informed of the type, the scope of use, the use scenario, etc. of the personal information involved in the present disclosure in an appropriate manner in accordance with relevant laws and regulations, and the user's authorization should be obtained.

For example, in response to receiving an active request from a user, a prompt information is sent to the user to explicitly prompt the user that the operation requested by the user will need to obtain and use the user's personal information. Thus, users may autonomously select whether to provide personal information to the software or the hardware such as an electronic device, an application, a server or a storage medium that perform the operation of the technical solution of the present disclosure according to the prompt information.

As an optional but non-restrictive implementation, in response to receiving an active request from a user, the way of sending prompt information to the user may be, for example, a pop-up window in which prompt information may be presented in text. In addition, pop-up windows may also contain selection controls for users to choose “agree” or “disagree” to provide personal information to electronic devices.

It will be appreciated that the above notification and acquisition of user authorization process are only schematic and do not limit the implementations of the present disclosure. Other methods that meet relevant laws and regulations may also be applied to the implementation of the present disclosure.

As used herein, the term “model” may learn an association relationship between respective inputs and outputs from training data, such that a corresponding output may be generated for a given input after training is complete. The generation of the model may be based on machine learning techniques. Deep learning is a machine learning algorithm that processes inputs and provides corresponding outputs by using a multi-layer processing unit. The neural network model is one example of a deep learning-based model. As used herein, a “model” may also be referred to as a “machine learning model,” a “learning model,” a “machine learning network,” or a “learning network,” which terms are used interchangeably herein.

A “neural network” is a deep learning-based machine learning network. The neural network is capable of processing inputs and providing respective outputs, which typically include an input layer and an output layer and one or more hidden layers between the input layer and the output layer. Neural networks used in deep learning applications typically include many hidden layers, thus increasing the depth of the network. Each layer of the neural network is connected in sequence, such that the output of the previous layer is provided as an input to the next layer. In this case, the input layer receives the input of the neural network, and the output of the output layer serves as the final output of the neural network. Each layer of the neural network includes one or more nodes (also referred to as processing nodes or neurons), and each node processes input from the previous layer.

Generally, machine learning may generally include three phases, i.e., a training phase, a testing phase, and an application phase (also referred to as an inference phase). At the training phase, a given model may be trained using a large amount of training data, constantly updating the parameter values iteratively until the model is able to obtain consistent inferences from the training data that satisfy the expected objectives. By training, the model may be considered to be able to learn from the training data an association from input to output (also referred to as mapping of input to output). The parameter values of the trained model are determined. In the testing phase, the test input is applied to the trained model to test whether the model can provide correct output, thereby determining the performance of the model. In the application phase, the model may be used to process the actual input based on the parameter value obtained by training to determine a corresponding output.

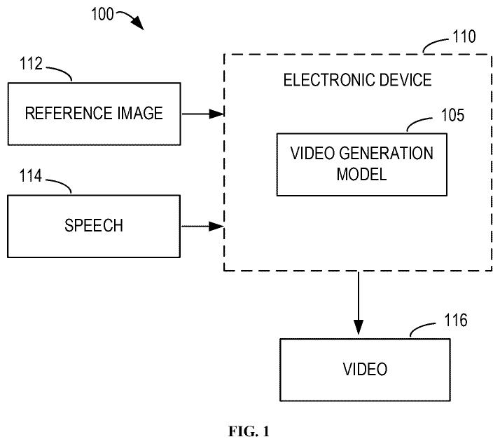

FIG. 1 illustrates a schematic diagram of an example environment 100 in which embodiments of the present disclosure can be implemented. In environment 100, electronic device 110 applies a video generation model 105 to generate a video. The video generation model 105 is configured to generate the video 116 based on the reference image 112 and the speech 114.

In some embodiments, the reference image 112 may include a reference object (e.g., a person), and the speech 114 includes a speech that is desired to be spoken by the reference object. The video 116 may represent a reference object speaking according to speech 114.

In environment 100, electronic device 110 may be any type of mobile terminal, fixed terminal, or portable terminal, including a mobile handset, desktop computer, laptop computer, notebook computer, netbook computer, tablet computer, media computer, multimedia tablet, personal communication system (PCS) device, personal navigation device, personal digital assistant (PDA), audio/video player, digital camera/camcorder, positioning device, television receiver, radio broadcast receiver, electronic book device, gaming device, or any combination of the foregoing, including accessories and peripherals of these devices, or any combination thereof. In some embodiments, the electronic device 110 may also support any type of interface for a user (such as a “wearable” circuit, etc.). The video generation model 105 may be implemented, for example, in various types of computing systems/servers capable of providing computing power, including, but not limited to, mainframes, edge computing nodes, computing devices in a cloud environment, and the like.

It should be understood that the structures and functions of the various elements in the environment 100 are described for illustrative purposes only and do not imply any limitation to the scope of the present disclosure.

As mentioned above, human face generation lacks interactivity. Some recent studies have started exploring human face generation through binary interaction, which means that the generated face needs to meet the role of the listener and the speaker, and can perform speaking or listening. However, these studies need to manually assign roles between listeners and speakers, and cannot achieve stable and natural role conversion.

Many practical applications are increasingly concerned with audio-driven face generation through binary interactions. Some related technologies design character converters to perform role conversion between listeners and speakers. However, displayed role conversion may lead to unnaturalness and inconsistency between different states. Furthermore, such a paradigm cannot cover all states in a binary conversation, such as a conversation agent and a conversation partner speaking simultaneously. Some related technologies employ a pre-training method to jointly simulate the action of a speaker and a listener to capture a binary context. In an application, the pre-trained model needs to perform additional fine-tuning for a downstream task, such as generating a face generation and listening face, respectively. Thus, manually assigning roles in binary conversations is necessary, which leads to improper conversion. In addition, there are other studies on binary interactions, but they are all specific to a particular individual without generalization capability.

In order to solve the above problem, in an embodiment of the present disclosure, a solution for generating a video is provided. Specifically, a reference image and a conversational speech are obtained, wherein the reference image comprises a target object, and the conversational speech comprises a target speech corresponding to the target object and an interactive speech for interacting with the target object. Based on the reference image, reference motion feature information and reference visual feature information corresponding to a face of the target object are generated. Interactive motion feature information of the conversational speech is extracted. Based on at least the interactive motion feature information, a motion feature information sequence corresponding to the conversational speech is determined. Further, a target video is generated based on the reference motion feature information, the reference visual feature information, and the motion feature information sequence. The target video comprises the target object speaking according to the target speech, and further comprises at least one of sound and motion of the target object during the interactive speech.

According to the solution of the present disclosure, the interactive motion feature information of the conversational speech may include the motion feature information of the target speech and the motion feature information of the interactive speech at the same time, and the target object may exhibit the corresponding motion feature information at a specific moment. In this way, a natural conversion between different states (e.g., listening and speaking) of a target object may be achieved without a manual role designation or a displayed role conversion.

Some example embodiments of the present disclosure will be described below with continued reference to the accompanying drawings.

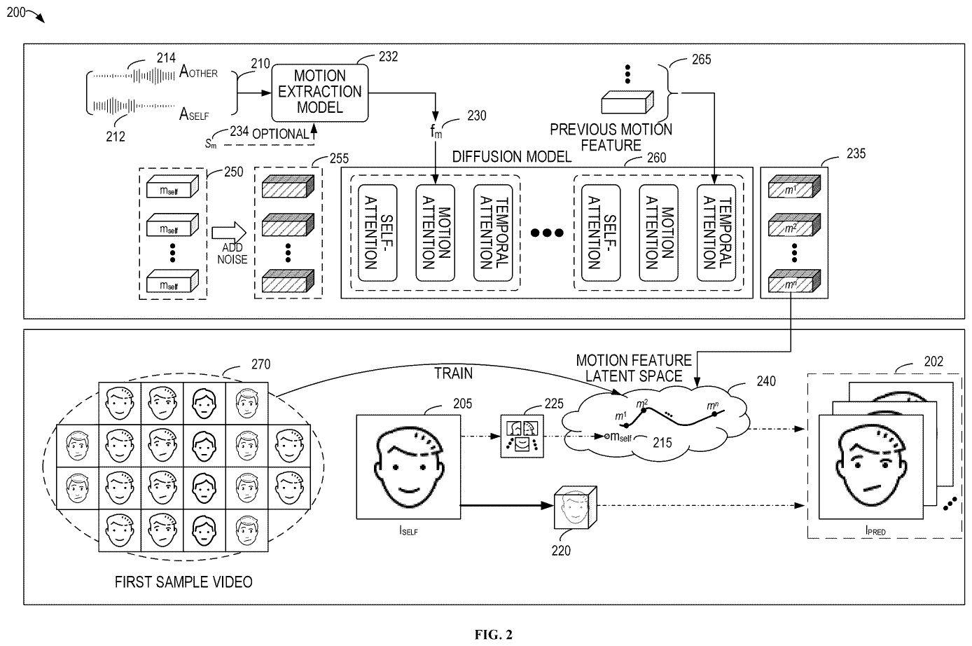

FIG. 2 illustrates an inference process 200 of a video generation model 105 according to some embodiments of the present disclosure. As shown in FIG. 2, to generate the target video 202, the reference image 205 (represented by I_{self}) and the conversational speech 210 for generating the target video 202 may be firstly obtained. In some embodiments, the reference image 205 may include a target object (e.g., person, cartoon character, animal, etc.). The conversational speech 210 may include a target speech 212 (represented by A_{self}) corresponding to the target object and an interactive speech 214 (represented by Aₒₜₕₑᵣ) for interacting with the target object. The target speech 212 may be a speech corresponding to content to be spoken by the target object, and the interactive speech 214 may be a speech corresponding to content to be spoken by the conversation partner of the target object.

In some embodiments, the target speech 212 and the interactive speech 214 may be acquired in real time or predetermined. In some examples, in a real-time conversation scenario, the target speech 212 and the interactive speech 214 may be acquired in real time. In a scenario of generating a video based on speech, the target speech 212 and the interactive speech 214 may be pre-recorded for generating a video. In some examples, in a scenario of text-to-speech generation, the target speech 212 and the interactive speech 214 may be generated based on a text conversation, and then the target speech 212 and the interactive speech 214 may be used to generate a video.

After the reference image 205 is obtained, the reference motion feature information 215 (represented by m_{self}) and the reference visual feature information 220 corresponding to the face of the target object may be generated based on the reference image 205. In some examples, the reference motion feature information 215 may characterize feature information related to facial motion of the target object (e.g., motion of the eyes and/or lips). The reference visual feature information 220 may characterize feature information irrelevant to the facial motion of the target object (e.g., appearance).

In some embodiments, reference motion feature information 215 may be located in motion feature latent space 240. In some examples, the character motion (e.g., mouth shape, expression, and head pose) in the reference image 205 may be mapped to this space, and converted into a feature vector of a low dimension (e.g., reference motion feature information 215).

In some embodiments, the reference motion feature information 215 may be a one-dimensional vector. According to an embodiment of the present disclosure, the reference motion feature information 215 is set as a one-dimensional vector, so that the reference motion feature information 215 includes as few character information of the target object as possible. In this way, the person information and the motion feature information can be decoupled, and the generalization of the motion feature information is improved.

In some embodiments, a visual encoder (not shown) may be used to extract the reference visual feature information 220 of the face of the target object from the reference image 205. For example, the visual encoder may extract three-dimensional appearance information from the reference image 205 as the reference visual feature information 220.

In some embodiments, the mask image 225 may be obtained by occluding an area of the reference image 205 irrelevant to the motion of the face of the target object. In some examples, most of the facial pixels in the reference image 205 may be blocked, leaving only eyes and lip areas, and then the mask image 225 may be obtained. The reference motion feature information 215 corresponding to the face of the target object is extracted from the mask image 225 by using a motion encoder (not shown). In this way, by retaining the most expressive part (for example, eyes and lips) in the facial expression in the mask image 225, the interference of motion-independent information such as background, hairstyle, clothing, facial features of different images may be eliminated, thereby improving the accuracy of the reference motion feature information 215.

In some embodiments, points related to a facial contour of the target object are projected to the mask image, by using a trained three-dimensional face keypoint model (not shown). In some examples, to provide face orientation and contour information, the face contour information (e.g., points related to the face contour of the target object) may be projected onto the mask image 225 using the trained three-dimensional face key point model. Then, the reference motion feature information 215 is extracted from the projected mask image 225 by using the motion encoder. In this way, the risk of identity information leakage of the target object can be reduced, and more expression details can be provided than the pure face key point.

After the reference motion feature information 215 and the reference visual feature information 220 are generated, the interactive motion feature information 230 (represented by fₘ) of the conversational speech 210 may be extracted. In some examples, the interactive motion feature information 230 may include both motion feature information of the target speech and motion feature information of the interactive speech. The interactive motion feature information 230 may be extracted by the motion extraction model 232.

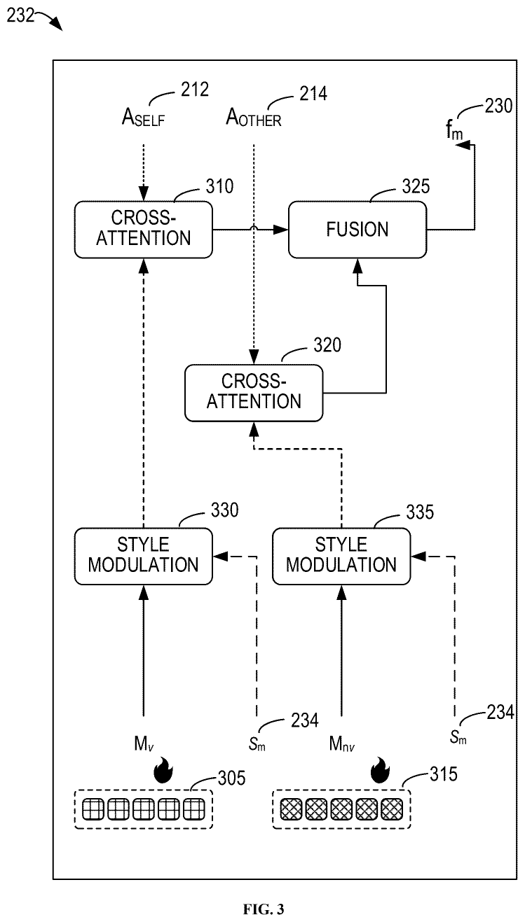

The process of extracting interactive motion feature information 230 will be described below with reference to FIG. 3. FIG. 3 illustrates a schematic architectural diagram of a motion extraction model 232 according to some embodiments of the present disclosure. As shown in FIG. 3, a first motion feature of the target speech may be obtained from a first motion feature library 305 (represented by Mᵥ). The first motion feature is associated with motion of the speaker, for example, the first motion feature may include lip motion, oral motion, motion of facial muscles, etc. of the speaker. The first motion feature library 305 stores correspondences between a plurality of speeches and a plurality of first motion features. In some examples, the first motion feature library 305 includes a plurality of learnable embedded representations (e.g., first motion features) to record motion of a particular speaker (e.g., motion corresponding to the target speech), which are represented by e^{1:K}, wherein eₖ∈ [symbol] represents the kth embedded representation, and d represents dimensions. Based on the embedded representation stored by the first motion feature library 305, a first motion feature may be determined.

After the first motion feature is obtained, the motion feature information of the target speech 212 may be determined based on the target speech 212 and the first motion feature. In some examples, the target speech 212 may be used as a query, the first motion feature obtained from the first motion feature library 305 is used as a key and a value, then the motion feature information of the target speech is determined by using the cross-attention layer 310.

Then, a second motion feature corresponding to the interactive speech may be obtained from the second motion feature library 315 (represented by Mₙᵥ), wherein the second motion feature is associated with motion of the non-speaker, for example, the second motion feature may include auricle motion, head steering motion, feedback motion, and the like of the non-speaker. The second motion feature library stores a correspondence between the plurality of speeches and the plurality of second motion features. In some examples, the first motion feature library 305 includes a plurality of learnable embedded representations (e.g., second motion features) to record motion of a particular non-speaker (e.g., motion corresponding to the interactive speech), which are represented by e^{1:K}, wherein e^{k}∈ [symbol] represents the kth embedded representation, and d represents dimensions. Based on the embedded representation stored by the second motion feature library 315, a second motion feature may be determined.

After the second motion feature is obtained, the motion feature information of the interactive speech 212 may be determined based on the interactive speech 214 and the second motion feature. In some examples, the interactive speech 214 may be used as a query, the second motion feature obtained from the second motion feature library 315 may be used as a key and a value, then the motion feature information of the target speech may be determined by using the cross-attention layer 320.

After the motion feature information of the target speech and the motion feature information of the interactive speech are determined, the interactive motion feature information 230 may be obtained by fusing the motion feature information of the target speech and the motion feature information of the interactive speech. In some examples, when the target object is speaking, the target speech 212 includes plenty of information, the interactive speech 214 includes very little information, and the motion feature information of the target speech and the motion feature information of the interactive speech are fused by fusion unit 325. In the fused motion feature information (also referred to as the interactive motion feature information 230), the motion feature information of the target speech dominates and drives the target object to present the speaking state. The fusion unit 325 may involve element-wise summation and multiple multi-layer perceptron (MLP) layers. In some examples, when the conversational partner of the target object is speaking, the interactive speech 214 includes plenty of information, the target speech 212 includes very little information, and the motion feature information of the target speech and the motion feature information of the interactive speech are fused by the fusion unit 325. In the fused motion feature information, the motion feature information of the interactive speech dominates and drives the target object to assume a listening state.

In this way, the interactive motion feature information 230 may be dynamically constructed based on the content of the conversational speech, such that the target object may present a corresponding state (e.g., a speaking state or a listening state). It should be noted that, before the corresponding motion feature information is determined by using the target speech 212 and the interactive speech 214, the target speech 212 and the interactive speech 214 may be encoded by the speech encoder to obtain a corresponding feature representation.

In some embodiments, the interactive motion feature information 230 may be extracted by the motion extraction model 232. The motion features in the first motion feature library 305 and the second motion feature library 315 are determined during training of the motion extraction model. In some examples, during the training of the motion extraction model 232, the correspondence between the speech and the motion features stored in the first motion feature library 305 and the second motion feature library 315 may be updated, so that the motion features corresponding to the target speech or the interactive speech may be obtained more accurately from the first motion feature library 305 and the second motion feature library 315.

In some embodiments, the first motion feature may be adjusted based on the style feature information 234 (represented by sₘ) indicating the speaking style. In some examples, as shown in FIG. 3, by the style modulation layer 330, the style feature information 234 may be introduced to explicitly edit the first motion feature, so that the first motion feature has a specific style. Then, the motion feature information of the target speech may be determined based on the target speech and the adjusted first motion feature.

In some embodiments, the second motion feature may be adjusted based on the style feature information 234. In some examples, by the style modulation layer 335, the style feature information 234 may be introduced to explicitly edit the second motion feature, such that the second motion feature has a particular style. Then, motion feature information of the interactive speech is determined based on the interactive speech and the adjusted second motion feature. Since the style feature information 234 includes global information such as emotion and attitude, the authenticity and the vividness in the motion feature information of the target speech and the motion feature information of the interactive speech may be improved.

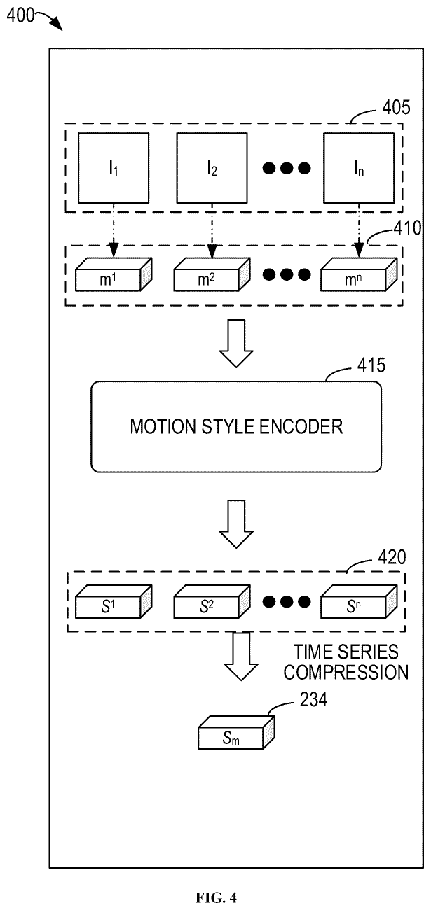

In some embodiments, the style feature information 234 may be extracted from the reference video which may include speech of the reference object. In some examples, the speech of the reference object has a particular style, e.g., calm, exciting, nervous, confident, etc. FIG. 4 illustrates a schematic diagram 400 of extracting style feature information 234 according to some embodiments of the present disclosure. As shown in FIG. 4, the reference video 405 includes a plurality of images (represented by l₁, l₂, . . . , lₙ). The plurality of images in the reference video 405 may be encoded as the reference motion feature sequence 410 (represented by m₁, m₂, . . . , mₙ) by using a motion encoder (not shown). Next, using the motion style encoder 415, the style feature sequence 420 may be extracted from the reference motion feature sequence 410, and the style feature sequence 420 may be compressed along the time dimension to obtain the style feature information 234. It should be noted that, in the training stage, the style feature information 234 may be from any video segment of the driven individual. During the inference stage, the style feature information 234 may be extracted from any video or set to null.

With continued reference to FIG. 2, after the interactive motion feature information 230 is extracted, the motion feature information sequence 235 corresponding to the conversational speech may be determined based on at least the interactive motion feature information 230.

In some embodiments, the motion feature information sequence 235 may be iteratively determined. For a predetermined round of the plurality of iteration rounds, the reference motion feature information sequence 250 including the plurality of copies of the reference motion feature information is generated by copying the reference motion feature information 215. The noise is added to the reference motion feature information sequence 250 to obtain a noisy reference motion feature information sequence 255. Next, by using a diffusion model 260, a denoising operation is performed on the noisy reference motion feature information sequence 255 based on the interactive motion feature information 230 and a part of motion features 265 of a motion feature information sequence determined in a previous round of the predetermined round, to determine the motion feature information sequence 235. In some examples, with the diffusion model 260, the interactive motion feature information 230 may be mapped into the motion feature latent space 240. Given the data distribution q(m^{1:N}, fₘ), wherein fₘ represents the interactive motion feature information 230, m^{1:N} represents a corresponding motion feature information sequence with N frames, the diffusion model 260 may estimate the conditional distribution q(m^{1:N}|fₘ). The diffusion model 260 may have a few number of blocks (e.g., 3 blocks, 4 blocks, 5 blocks, etc.), such that the video generation model 105 proposed by the present disclosure is lightweight enough to enable real-time interaction.

In some embodiments, each block in the diffusion model 260 may include a self-attention layer 262, a motion attention layer 264, and a temporal attention layer 266. The diffusion model 260 predicts the noise added to the reference motion feature information sequence 250 in each denoising step. The diffusion time step is converted to a sinusoidal embedding and then concatenated with noisy motion latent code in the temporal dimension. In the motion attention layer 264, the output of the self-attention layer 262 may be used as a query, and the interactive motion feature information 230 may be used as a key and a value. In addition, the temporal attention layer 266 may use a part of motion feature 265 of the motion feature information sequence determined in the previous round as a condition for determining the motion feature information sequence 235, thereby ensuring a smooth transition of the motion feature information sequence generated by the adjacent rounds.

After the motion feature information sequence 235 is determined, the target video 202 may be generated based on the reference motion feature information, the reference visual feature information, and the motion feature information sequence 235. The target video 202 may include a target object speaking according to a target speech 212, and further includes at least one of the voice and motion of the target object during the interactive speech 214. For example, the target object may physically respond (e.g., nod, smile, etc.) to the interactive speech 214 during the interactive speech 214. The target object may linguistically respond to the interactive speech 214 during the interactive speech 214. In some examples, the motion stream may be predicted using the motion stream estimation model based on the reference motion feature information 215 and the motion feature information sequence 235. The reference visual feature information 220 performs a warping operation through the motion stream, and the target video 202 may be generated by the decoder. The above process may be represented as follows:

$${Flow}_{s \to d} = F ( {E}_{m} ( {I}_{self} ) , {E}_{m} ( {V}_{d r t} ) ) {I}_{p r e d}^{1 : N} = {D}_{face} ( Warp ( {E}_{face} ( {I}_{self} ) , {Flow}_{s \to d} ) ) \qquad ( 1 )$$

wherein Eₘ (I_{self}) represents a reference motion feature information 215, Eₘ (V_{drt}) represents a motion feature information sequence 235, Flow_{s→d} represents a motion stream, Warp(⋅) represents a warping operation, E_{face} (I_{self}) represents reference visual feature information 220, and

$${I}_{p r e d}^{1 : N}$$

represents a target video 202.

In some embodiments, the motion feature information sequence 235 may be located in the motion feature latent space 240. The motion feature latent space 240 may be determined from the training of a motion encoder, a visual encoder, and a decoder for video generation.

In some embodiments, the motion encoder, the visual encoder, and the decoder may be trained with the first sample video 270. First, a first sample video 270 may be obtained, wherein the first sample video 270 may include a plurality of sample images, and the plurality of sample images include sample objects. For each sample image in the first sample video, the sample image is sampled by using a motion encoder under training, to obtain sample motion feature information (for example, the feature information related to the movement of the face) of the sample object in the motion feature latent space 240. The sample image is encoded by using a visual encoder under training, to obtain sample visual feature information of the sample object (for example, the feature information related to appearance). Based on the sample motion feature information and the sample visual feature information, a reconstructed image corresponding to the sample image is generated by using a decoder under training. Then, the motion encoder, the visual encoder, and the decoder are trained based on a first training objective, wherein the first training objective is configured to reduce or minimize a difference between the sample image and the reconstructed image. When the motion encoder, the visual encoder and the decoder are trained, the motion encoder needs to continuously encode the sample image into sample motion feature information in the motion feature latent space, and the decoder needs to continuously decode the sample motion feature information into a reconstructed image. Therefore, the quality of the motion feature latent space can be continuously improved.

In some embodiments, the interactive motion feature information 230 may be extracted by a trained motion extraction model 232, and the motion feature information sequence 235 may be generated by a trained diffusion model 260, and the motion extraction model and the diffusion model are trained by using a second sample video. Firstly, the second sample video may be acquired, wherein the second sample video comprises a sample conversational speech and a plurality of sample images. A sample motion feature information sequence may be generated based on the plurality of sample images. In an example, the plurality of sample images may be encoded as motion feature information sequence in the motion latent space 240 by using the motion encoder. The sample interactive motion feature information may be extracted from the sample conversational speech by using a motion extraction model under training. Based on at least the sample interactive motion feature information, a reconstructed motion feature information sequence for the sample conversational speech may be determined by using a diffusion model under training. In an example, the reconstructed motion feature information sequence is also located in the motion latent space 240. Then, the motion extraction model and the diffusion model may be trained based on a second training objective, wherein the second training objective is configured to reduce or minimize a difference between the sample motion feature information sequence and the reconstructed motion feature information sequence.

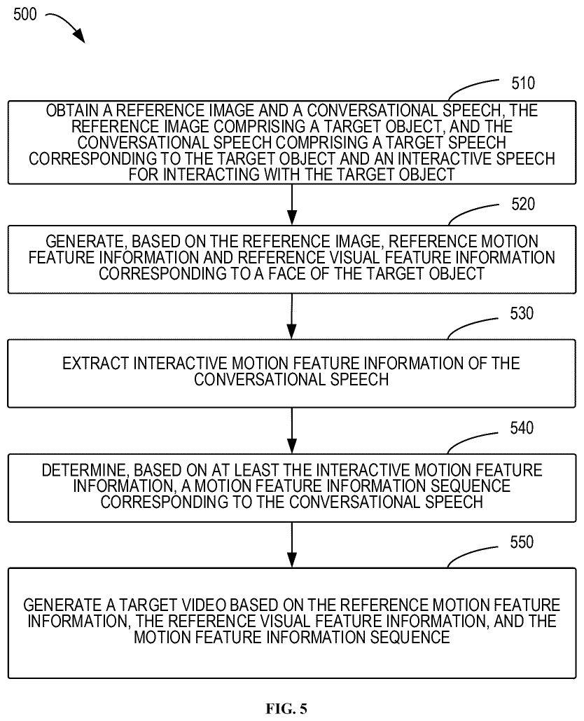

FIG. 5 shows a flowchart of a method 500 for generating a video according to some embodiments of the present disclosure. The method 500 may be implemented at the electronic device 110 of FIG. 1. The method 500 will be described with reference to the environment 100 of FIG. 1.

At block 510, the electronic device 110 obtains a reference image and a conversational speech, wherein the reference image comprises a target object, and the conversational speech comprises a target speech corresponding to the target object and an interactive speech for interacting with the target object.

At block 520, the electronic device 110 generates, based on the reference image, reference motion feature information and reference visual feature information corresponding to a face of the target object.

At block 530, the electronic device 110 extracts interactive motion feature information of the conversational speech.

At block 540, the electronic device 110 determines, based on at least the interactive motion feature information, a motion feature information sequence corresponding to the conversational speech.

At block 550, the electronic device 110 generates a target video based on the reference motion feature information, the reference visual feature information, and the motion feature information sequence.

In some embodiments, extracting the interactive motion feature information comprises: obtaining a first motion feature of the target speech from a first motion feature library, the first motion feature library storing correspondences between a plurality of speeches and a plurality of first motion features; determining motion feature information of the target speech based on the target speech and the first motion feature; obtaining a second motion feature corresponding to the interactive speech from a second motion feature library, the second motion feature library storing correspondences between the plurality of speeches and a plurality of second motion features; determining motion feature information of the interactive speech based on the interactive speech and the second motion feature; and obtaining the interactive motion feature information by fusing the motion feature information of the target speech and the motion feature information of the interactive speech.

In some embodiments, determining the motion feature information of the target speech comprises: adjusting the first motion feature based on style feature information indicating a speaking style; and determining the motion feature information of the target speech based on the target speech and the adjusted first motion feature; and wherein determining the motion feature information of the interactive speech comprises: adjusting the second motion feature based on the style feature information; and determining the motion feature information of the interactive speech based on the interactive speech and the adjusted second motion feature.

In some embodiments, the method 500 further comprises: extracting the style feature information from a reference video.

In some embodiments, generating, based on the reference image, the reference motion feature information and the reference visual feature information corresponding to the face of the target object comprises: extracting, by using a visual encoder, the reference visual feature information corresponding to the face of the target object, from the reference image; obtaining a mask image by occluding, in the reference image, an area irrelevant to the movement of the face of the target object; and extracting, by using a motion encoder, the reference motion feature information corresponding to the face of the target object, from the mask image.

In some embodiments, extracting the reference motion feature information corresponding to the face of the target object from the mask image comprises: projecting points related to a facial contour of the target object to the mask image, by using a trained three-dimensional face keypoint model; and extracting the reference motion feature information from the projected mask image, by using the motion encoder.

In some embodiments, the motion feature information sequence is iteratively determined, and wherein determining the motion feature information sequence comprises, for a predetermined round of a plurality of iteration rounds: generating, by copying the reference motion feature information, a reference motion feature information sequence comprising a plurality of copies of the reference motion feature information; adding noise to the reference motion feature information sequence to obtain a noisy reference motion feature information sequence; performing, by using a diffusion model, a denoising operation on the noisy reference motion feature information sequence based on the interactive motion feature information and a part of motion features of a motion feature information sequence determined in a previous round of the predetermined round, to determine the motion feature information sequence.

In some embodiments, the reference motion feature information and the motion feature information sequence are located in a motion feature latent space, and the motion feature latent space is determined from training of a motion encoder, a visual encoder, and a decoder for video generation.

In some embodiments, the motion encoder, the visual encoder, and the decoder are trained by: obtaining a first sample video comprising a plurality of sample images, the plurality of sample images comprising a sample object; for each sample image in the first sample video, encoding the sample image by using a motion encoder under training, to obtain sample motion feature information of the sample object in the motion feature latent space; encoding the sample image by using a visual encoder under training, to obtain sample visual feature information of the sample object; generating, based on the sample motion feature information and the sample visual feature information, a reconstructed image corresponding to the sample image, by using a decoder under training; training the motion encoder, the visual encoder, and the decoder based on a first training objective, the first training objective configured to reduce or minimize a difference between the sample image and the reconstructed image.

In some embodiments, the interactive motion feature information is extracted by a trained motion extraction model, and the motion feature information sequence is generated by a trained diffusion model, and wherein the motion extraction model and the diffusion model are trained by: obtaining a second sample video, the second sample video comprising a sample conversational speech and a plurality of sample images; generating a sample motion feature information sequence based on the plurality of sample images; extracting sample interactive motion feature information from the sample conversational speech by using a motion extraction model under training; determining, based on at least the sample interactive motion feature information, a reconstructed motion feature information sequence for the sample conversational speech by using a diffusion model under training; and training the motion extraction model and the diffusion model based on a second training objective, the second training objective configured to reduce or minimize a difference between the sample motion feature information sequence and the reconstructed motion feature information sequence.

In some embodiments, the target speech and the interactive speech are collected in real time or predetermined.

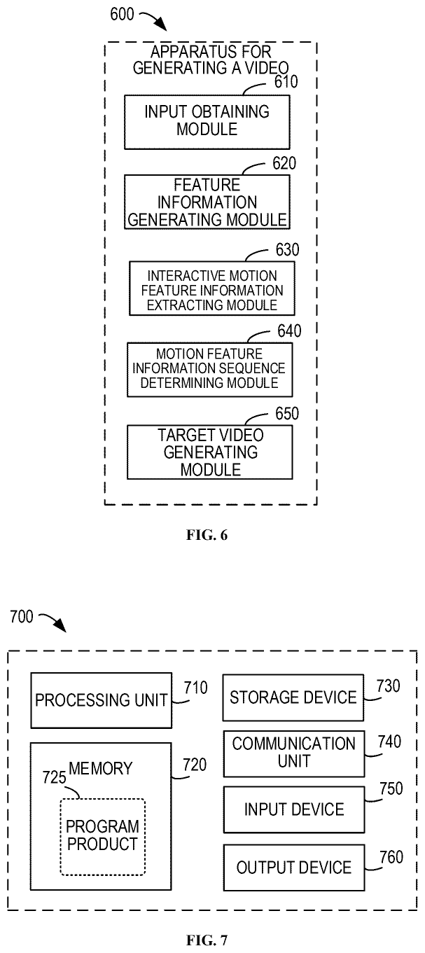

The embodiments of the present disclosure also provide a corresponding apparatus for implementing the above method or process. FIG. 6 shows an example structural block diagram of an apparatus 600 for generating a video according to some embodiments of the present disclosure. The apparatus 600 may be implemented as or included in the electronic device 110. The various modules/components in the apparatus 600 may be implemented by hardware, software, firmware, or any combination thereof.

As shown in FIG. 6, the apparatus 600 includes: an input obtaining module 610 configured to obtain a reference image and a conversational speech, the reference image comprising a target object, and the conversational speech comprising a target speech corresponding to the target object and an interactive speech for interacting with the target object; a feature information generating module 620 configured to generate, based on the reference image, reference motion feature information and reference visual feature information corresponding to a face of the target object; an interactive motion feature information extracting module 630 configured to extract interactive motion feature information of the conversational speech; a motion feature information sequence determining module 640 configured to determine, based on at least the interactive motion feature information, a motion feature information sequence corresponding to the conversational speech; and a target video generating module 650 configured to generate a target video based on the reference motion feature information, the reference visual feature information, and the motion feature information sequence.

In some embodiments, the interactive motion feature information extracting module 630 is further configured to: obtain a first motion feature of the target speech from a first motion feature library, the first motion feature library storing correspondences between a plurality of speeches and a plurality of first motion features; determine motion feature information of the target speech based on the target speech and the first motion feature; obtain a second motion feature corresponding to the interactive speech from a second motion feature library, the second motion feature library storing correspondences between the plurality of speeches and a plurality of second motion features; determine motion feature information of the interactive speech based on the interactive speech and the second motion feature; and obtain the interactive motion feature information by fusing the motion feature information of the target speech and the motion feature information of the interactive speech.

In some embodiments, the interactive motion feature information extracting module 630 is further configured to: adjust the first motion feature based on style feature information indicating a speaking style; and determine the motion feature information of the target speech based on the target speech and the adjusted first motion feature. The interactive motion feature information extracting module 630 is further configured to: adjust the second motion feature based on the style feature information; and determine the motion feature information of the interactive speech based on the interactive speech and the adjusted second motion feature.

In some embodiments, the apparatus 600 further comprises a style feature information extracting module configured to extract the style feature information from a reference video.

In some embodiments, the feature information generating module 620 is further configured to: extract, by using a visual encoder, the reference visual feature information corresponding to the face of the target object, from the reference image; obtain a mask image by occluding, in the reference image, an area irrelevant to the movement of the face of the target object; and extract, by using a motion encoder, the reference motion feature information corresponding to the face of the target object, from the mask image.

In some embodiments, the feature information generating module 620 is further configured to: project points related to a facial contour of the target object to the mask image, by using a trained three-dimensional face keypoint model; and extract the reference motion feature information from the projected mask image, by using the motion encoder.

In some embodiments, the motion feature information sequence is iteratively determined, and wherein the motion feature information sequence determining module 640 is further configured to: for a predetermined round of a plurality of iteration rounds, generating, by copying the reference motion feature information, a reference motion feature information sequence comprising a plurality of copies of the reference motion feature information; add noise to the reference motion feature information sequence to obtain a noisy reference motion feature information sequence; perform, by using a diffusion model, a denoising operation on the noisy reference motion feature information sequence based on the interactive motion feature information and a part of motion features of a motion feature information sequence determined in a previous round of the predetermined round, to determine the motion feature information sequence.

In some embodiments, the reference motion feature information and the motion feature information sequence are located in a motion feature latent space, and the motion feature latent space is determined from training of a motion encoder, a visual encoder, and a decoder for video generation.

In some embodiments, the motion encoder, the visual encoder, and the decoder are trained by: obtaining a first sample video comprising a plurality of sample images, the plurality of sample images comprising a sample object; for each sample image in the first sample video, encoding the sample image by using a motion encoder under training, to obtain sample motion feature information of the sample object in the motion feature latent space; encoding the sample image by using a visual encoder under training, to obtain sample visual feature information of the sample object; generating, based on the sample motion feature information and the sample visual feature information, a reconstructed image corresponding to the sample image, by using a decoder under training; training the motion encoder, the visual encoder, and the decoder based on a first training objective, the first training objective configured to reduce or minimize a difference between the sample image and the reconstructed image.

In some embodiments, the interactive motion feature information is extracted by a trained motion extraction model, and the motion feature information sequence is generated by a trained diffusion model, and wherein the motion extraction model and the diffusion model are trained by: obtaining a second sample video, the second sample video comprising a sample conversational speech and a plurality of sample images; generating a sample motion feature information sequence based on the plurality of sample images; extracting sample interactive motion feature information from the sample conversational speech by using a motion extraction model under training; determining, based on at least the sample interactive motion feature information, a reconstructed motion feature information sequence for the sample conversational speech by using a diffusion model under training; and training the motion extraction model and the diffusion model based on a second training objective, the second training objective configured to reduce or minimize a difference between the sample motion feature information sequence and the reconstructed motion feature information sequence.

In some embodiments, the target speech and the interactive speech are collected in real time or predetermined.

The units and/or modules included in the apparatus 600 may be implemented in various manners, including software, hardware, firmware, or any combination thereof. In some embodiments, one or more units and/or modules may be implemented using software and/or firmware, such as machine-executable instructions stored on a storage medium. In addition to or as an alternative to machine-executable instructions, some or all of the units and/or modules in the apparatus 600 may be implemented, at least in part, by one or more hardware logic components. By way of example and not limitation, illustrative types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

It should be understood that one or more steps of the above method may be performed by a suitable electronic device or a combination of electronic devices. Such an electronic device or combinations of electronic devices may include, for example, the electronic device 110 in FIG. 1.

FIG. 7 shows a block diagram of an electronic device 700 for implementing one or more embodiments of the present disclosure. The electronic device 700 shown in FIG. 7 is merely an example and should not be construed to impose any limitations on the functionality and use scope of the embodiments of the present disclosure. The electronic device 700 shown in FIG. 7 may be used to implement the electronic device 110 shown in FIG. 1 or the apparatus 600 shown in FIG. 6.

As shown in FIG. 7, the electronic device 700 is in the form of a general-purpose electronic device. Components of the electronic device 700 may include, but are not limited to, one or more processors or processing units 710, a memory 720, a storage device 730, one or more communication units 740, one or more input devices 750, and one or more output devices 760. The processing unit 710 may be an actual or virtual processor and capable of performing various processes according to programs stored in memory 720. In multiprocessor systems, multiple processing units execute computer-executable instructions in parallel to improve parallel processing capabilities of electronic device 700.

The electronic device 700 typically includes a plurality of computer storage media. Such media may be any available media accessible to the electronic device 700, including, but not limited to, volatile and non-volatile media, removable and non-removable media. The memory 720 may be volatile memory (e.g., registers, caches, random access memory (RAM)), non-volatile memory (e.g., read-only memory (ROM), electrically erasable programmable read-only memory (EEPROM), flash memory), or some combination thereof. The storage device 730 may be a removable or non-removable medium and may include a machine-readable medium, such as a flash drive, magnetic disk, or any other medium, which may be capable of storing information and/or data and may be accessed within electronic device 700.

The electronic device 700 may further include additional removable/non-removable, volatile/non-volatile storage media. Although not shown in FIG. 7, a disk drive for reading from or writing into a removable, nonvolatile magnetic disk (e.g., a “floppy disk”) and an optical disk drive for reading from or writing into a removable, nonvolatile optical disk may be provided. In these cases, each drive may be connected to a bus (not shown) by one or more data media interfaces. The memory 720 may include a computer program product 725 having one or more program modules configured to perform various methods or actions of various embodiments of the present disclosure.

The communication unit 740 is configured to communicate with another electronic device through a communication medium. Additionally, the functionality of components of the electronic device 700 may be implemented in a single computing cluster or multiple computing machines capable of communicating over a communication connection. Thus, the electronic device 700 may operate in a networked environment using logical connections with one or more other servers, network personal computers (PCs), or another network node.

The input device 750 may be one or more input devices, such as a mouse, a keyboard, a trackball, or the like. The output device 760 may be one or more output devices, such as a display, a speaker, a printer, or the like. The electronic device 700 may also communicate with one or more external devices (not shown) through the communication unit 740 as needed, the external devices are such as storage devices, display devices, etc., communicate with one or more devices that enable a user to interact with the electronic device 700, or communicate with any device (e.g., a network card, a modem, etc.) that enables the electronic device 700 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions that, when executed by a processor, implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other devices, such that a series of operational steps are performed on a computer, other programmable data processing apparatus, or other device to produce a computer-implemented process, such that the instructions executed on a computer, other programmable data processing apparatus, or other device implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some implementations as an update, the functions noted in the blocks may also occur in a different order than that shown in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for generating a video, comprising:
obtaining a reference image and a conversational speech, the reference image comprising a target object, and the conversational speech comprising a target speech corresponding to the target object and an interactive speech for interacting with the target object;
generating, based on the reference image, reference motion feature information and reference visual feature information corresponding to a face of the target object;
extracting interactive motion feature information of the conversational speech;
determining, based on at least the interactive motion feature information, a motion feature information sequence corresponding to the conversational speech; and
generating a target video based on the reference motion feature information, the reference visual feature information, and the motion feature information sequence.

2. The method of claim 1, wherein extracting the interactive motion feature information comprises:
obtaining a first motion feature of the target speech from a first motion feature library, the first motion feature library storing correspondences between a plurality of speeches and a plurality of first motion features;
determining motion feature information of the target speech based on the target speech and the first motion feature;
obtaining a second motion feature corresponding to the interactive speech from a second motion feature library, the second motion feature library storing correspondences between the plurality of speeches and a plurality of second motion features;
determining motion feature information of the interactive speech based on the interactive speech and the second motion feature; and
obtaining the interactive motion feature information by fusing the motion feature information of the target speech and the motion feature information of the interactive speech.

3. The method of claim 2, wherein determining the motion feature information of the target speech comprises:
adjusting the first motion feature based on style feature information indicating a speaking style; and
determining the motion feature information of the target speech based on the target speech and the adjusted first motion feature; and
wherein determining the motion feature information of the interactive speech comprises:
adjusting the second motion feature based on the style feature information; and
determining the motion feature information of the interactive speech based on the interactive speech and the adjusted second motion feature.

4. The method of claim 3, further comprising:
extracting the style feature information from a reference video.

5. The method of claim 1, wherein generating, based on the reference image, the reference motion feature information and the reference visual feature information corresponding to the face of the target object comprises:
extracting, by using a visual encoder, the reference visual feature information corresponding to the face of the target object, from the reference image;
obtaining a mask image by occluding, in the reference image, an area irrelevant to the movement of the face of the target object; and
extracting, by using a motion encoder, the reference motion feature information corresponding to the face of the target object, from the mask image.

6. The method of claim 5, wherein extracting the reference motion feature information corresponding to the face of the target object from the mask image comprises:
projecting points related to a facial contour of the target object to the mask image, by using a trained three-dimensional face keypoint model; and
extracting the reference motion feature information from the projected mask image, by using the motion encoder.

7. The method of claim 1, wherein the motion feature information sequence is iteratively determined, and wherein determining the motion feature information sequence comprises, for a predetermined round of a plurality of iteration rounds:
generating, by copying the reference motion feature information, a reference motion feature information sequence comprising a plurality of copies of the reference motion feature information;
adding noise to the reference motion feature information sequence to obtain a noisy reference motion feature information sequence;
performing, by using a diffusion model, a denoising operation on the noisy reference motion feature information sequence based on the interactive motion feature information and a part of motion features of a motion feature information sequence determined in a previous round of the predetermined round, to determine the motion feature information sequence.

8. The method of claim 1, wherein the reference motion feature information and the motion feature information sequence are located in a motion feature latent space, the motion feature latent space being determined from training of a motion encoder, a visual encoder, and a decoder for video generation.

9. The method of claim 8, wherein the motion encoder, the visual encoder, and the decoder are trained by:
obtaining a first sample video comprising a plurality of sample images, the plurality of sample images comprising a sample object;
for each sample image in the first sample video,
encoding the sample image by using a motion encoder under training, to obtain sample motion feature information of the sample object in the motion feature latent space;
encoding the sample image by using a visual encoder under training, to obtain sample visual feature information of the sample object;
generating, based on the sample motion feature information and the sample visual feature information, a reconstructed image corresponding to the sample image, by using a decoder under training;
training the motion encoder, the visual encoder, and the decoder based on a first training objective, the first training objective configured to reduce or minimize a difference between the sample image and the reconstructed image.

10. The method of claim 1, wherein the interactive motion feature information is extracted by a trained motion extraction model, and the motion feature information sequence is generated by a trained diffusion model, and wherein the motion extraction model and the diffusion model are trained by:
obtaining a second sample video, the second sample video comprising a sample conversational speech and a plurality of sample images;
generating a sample motion feature information sequence based on the plurality of sample images;
extracting sample interactive motion feature information from the sample conversational speech by using a motion extraction model under training;
determining, based on at least the sample interactive motion feature information, a reconstructed motion feature information sequence for the sample conversational speech by using a diffusion model under training; and
training the motion extraction model and the diffusion model based on a second training objective, the second training objective configured to reduce or minimize a difference between the sample motion feature information sequence and the reconstructed motion feature information sequence.

11. The method of claim 1, wherein the target speech and the interactive speech are collected in real time or predetermined.

12. An electronic device, comprising:
at least one processor; and
at least one memory coupled to the at least one processor and storing instructions for execution by the at least one processor, the instructions, when executed by the at least one processor, causing the electronic device to perform acts comprising:
obtaining a reference image and a conversational speech, the reference image comprising a target object, and the conversational speech comprising a target speech corresponding to the target object and an interactive speech for interacting with the target object;
generating, based on the reference image, reference motion feature information and reference visual feature information corresponding to a face of the target object;
extracting interactive motion feature information of the conversational speech;
determining, based on at least the interactive motion feature information, a motion feature information sequence corresponding to the conversational speech; and
generating a target video based on the reference motion feature information, the reference visual feature information, and the motion feature information sequence.

13. The electronic device of claim 12, wherein extracting the interactive motion feature information comprises:
obtaining a first motion feature of the target speech from a first motion feature library, the first motion feature library storing correspondences between a plurality of speeches and a plurality of first motion features;
determining motion feature information of the target speech based on the target speech and the first motion feature;
obtaining a second motion feature corresponding to the interactive speech from a second motion feature library, the second motion feature library storing correspondences between the plurality of speeches and a plurality of second motion features;
determining motion feature information of the interactive speech based on the interactive speech and the second motion feature; and
obtaining the interactive motion feature information by fusing the motion feature information of the target speech and the motion feature information of the interactive speech.

14. The electronic device of claim 13, wherein determining the motion feature information of the target speech comprises:
adjusting the first motion feature based on style feature information indicating a speaking style; and
determining the motion feature information of the target speech based on the target speech and the adjusted first motion feature; and
wherein determining the motion feature information of the interactive speech comprises:
adjusting the second motion feature based on the style feature information; and
determining the motion feature information of the interactive speech based on the interactive speech and the adjusted second motion feature.

15. The electronic device of claim 14, the acts further comprising:
extracting the style feature information from a reference video.

16. The electronic device of claim 12, wherein generating, based on the reference image, the reference motion feature information and the reference visual feature information corresponding to the face of the target object comprises:
extracting, by using a visual encoder, the reference visual feature information corresponding to the face of the target object, from the reference image;
obtaining a mask image by occluding, in the reference image, an area irrelevant to the movement of the face of the target object; and
extracting, by using a motion encoder, the reference motion feature information corresponding to the face of the target object, from the mask image.

17. The electronic device of claim 16, wherein extracting the reference motion feature information corresponding to the face of the target object from the mask image comprises:
projecting points related to a facial contour of the target object to the mask image, by using a trained three-dimensional face keypoint model; and
extracting the reference motion feature information from the projected mask image, by using the motion encoder.

18. The electronic device of claim 12, wherein the motion feature information sequence is iteratively determined, and wherein determining the motion feature information sequence comprises, for a predetermined round of a plurality of iteration rounds:
generating, by copying the reference motion feature information, a reference motion feature information sequence comprising a plurality of copies of the reference motion feature information;
adding noise to the reference motion feature information sequence to obtain a noisy reference motion feature information sequence;
performing, by using a diffusion model, a denoising operation on the noisy reference motion feature information sequence based on the interactive motion feature information and a part of motion features of a motion feature information sequence determined in a previous round of the predetermined round, to determine the motion feature information sequence.

19. The electronic device of claim 12, wherein the reference motion feature information and the motion feature information sequence are located in a motion feature latent space, the motion feature latent space being determined from training of a motion encoder, a visual encoder, and a decoder for video generation.

20. A non-transitory computer-readable storage medium having stored thereon a computer program that, when executed by a processor, implements a method comprising:
obtaining a reference image and a conversational speech, the reference image comprising a target object, and the conversational speech comprising a target speech corresponding to the target object and an interactive speech for interacting with the target object;
generating, based on the reference image, reference motion feature information and reference visual feature information corresponding to a face of the target object;
extracting interactive motion feature information of the conversational speech;
determining, based on at least the interactive motion feature information, a motion feature information sequence corresponding to the conversational speech; and
generating a target video based on the reference motion feature information, the reference visual feature information, and the motion feature information sequence.
